(19) United States
(12) Patent Application Publication
(10) Pub. No.: US 2016/0253683 A1
(43) Pub. Date: Sep. 1, 2016

(54) SAMPLING OF USERS IN NETWORK A/B TESTING

(71) Applicant: LinkedIn Corporation, Mountain View, CA (US)

(72) Inventors: Huan Gui, Urbana, IL (US); Ya Xu, Los Altos, CA (US); Anmol Bhasin, Los Altos, CA (US); Jiawei Han, Urbana, IL (US)

(73) Assignee: LinkedIn Corporation, Mountain View, CA (US)

(21) Appl. No.: 14/632,344

(22) Filed: Feb. 26, 2015

(51) Int. Cl. G06Q 30/02; G06Q 50/00

(52) U.S. Cl. CPC G06Q 30/0201; G06Q 30/0203; G06Q 50/01

(57) ABSTRACT

The disclosed embodiments provide a system for performing network A/B testing. During operation, the system obtains a graph of a social network and calculates a set of equally sized clusters of users in the social network by iteratively switching memberships of the nodes among the equally sized clusters to increase a number of edges in each of the equally sized clusters. Next, the system randomly selects a subset of the equally sized clusters for exposure to a treatment version of a message. The system then performs an A/B test by presenting the treatment version to the selected clusters and tracking a response of the selected clusters to the treatment version.

### RELATED APPLICATION

The subject matter of this application is related to the subject matter in a co-pending non-provisional application by the same inventors as the instant application and filed on the same day as the instant application, entitled “Bias Correction and Estimation in Network A/B Testing,” having Ser. No. TO BE ASSIGNED, and filing date of 26 Feb. 2015 (Attorney Docket No. LI-P1444.LNK.US).

### BACKGROUND

1. Field

The disclosed embodiments relate to A/B testing. More specifically, the disclosed embodiments relate to techniques for sampling users in network A/B testing.

2. Related Art

A/B testing is a standard way to evaluate user engagement or satisfaction with a new service, feature, or product. For example, a social networking service may use an A/B test to show two versions of a web page, email, offer, article, social media post, advertisement, layout, design, and/or other information or content to users to determine if one version has a higher conversion rate than the other. If results from the A/B test show that a new treatment version performs better than an old control version by a certain amount, the test results may be considered statistically significant, and the new version may be used in subsequent communications with users already exposed to the treatment version and/or additional users.

A/B testing is typically conducted under the Stable Unit Treatment Value Assumption (SUTVA), which states that the behavior of each user in an A/B test depends only on the user's treatment and not on the treatment of other users in the A/B test. However, a social network setting typically exhibits network effect, in which a user's behavior is likely impacted by the behavior of the user's social neighborhood. For example, the user may find a new feature more valuable, and thus be more likely to adopt the new feature, if more of the user's connections in the social network adopt the new feature. Thus, if a treatment version in an A/B test has a significant impact on the user, the effect of the treatment version may spill over to the user's social circles, independently of whether the user's neighbors are in the treatment or control groups of the A/B test.

In turn, A/B testing of social networks that does not account for network effect may be biased and produce incorrect results. For example, an A/B test of a social network (e.g., a network A/B test) that operates under SUTVA may predict lift in click-through rate (CTR) from exposure of everyone in the social network to the treatment version to be significantly lower than the actual CTR lift caused by exposure to treatment because of spillover effects from the treatment group to the control group and/or from the control group to the treatment group.

Consequently, A/B testing of social networks may be facilitated by mechanisms for accounting for network effect during sampling of users and evaluation of A/B testing results.

### BRIEF DESCRIPTION OF THE FIGURES

FIG. 1 shows a schematic of a system in accordance with the disclosed embodiments.

FIG. 2 shows a system for performing network A/B testing in accordance with the disclosed embodiments.

FIG. 3 shows an exemplary calculation of a set of equally sized clusters of users in a social network in accordance with the disclosed embodiments.

FIG. 4 shows the estimation of an average treatment effect (ATE) for a network A/B test in accordance with the disclosed embodiments.

FIG. 5 shows a flowchart illustrating the process of sampling users in network A/B testing in accordance with the disclosed embodiments.

FIG. 6 shows a flowchart illustrating the process of calculating equally sized clusters of users in a social network in accordance with the disclosed embodiments.

FIG. 7 shows a flowchart illustrating the process of performing bias correction and estimation in network A/B testing in accordance with the disclosed embodiments.

FIG. 8 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

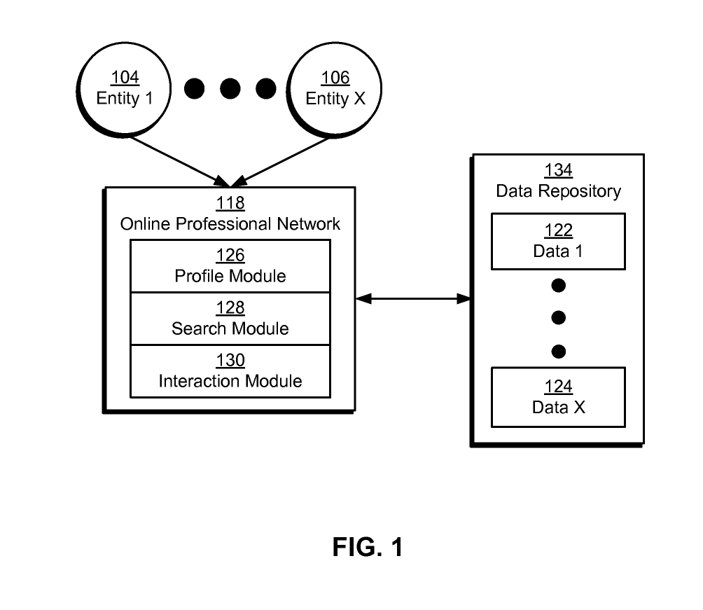

The disclosed embodiments provide a method and system for performing A/B testing. More specifically, the disclosed embodiments provide a method and system for performing A/B testing in a social network setting. As shown in FIG. 1, a social network may include an online professional network 118 that is used by a set of entities (e.g., entity 1 104, entity x 106) to interact with one another in a professional and/or business context.

For example, the entities may include users that use online professional network 118 to establish and maintain professional connections, list work and community experience, endorse and/or recommend one another, search and apply for jobs, and/or perform other actions. The entities may also include companies, employers, and/or recruiters that use online professional network 118 to list jobs, search for potential candidates, provide business-related updates to users, advertise, and/or take other action.

The entities may use a profile module 126 in online professional network 118 to create and edit profiles containing information related to the entities' professional and/or industry backgrounds, experiences, summaries, projects, skills, and so on. Profile module 126 may also allow the entities to view the profiles of other entities in online professional network 118.

The entities may use a search module 128 to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature on online professional network 118 to search for profiles, jobs, and/or information by categories such as first name, last name, title, company, school, location, interests, relationship, industry, groups, salary, experience level, etc.

The entities may also use an interaction module 130 to interact with other entities on online professional network 118. For example, interaction module 130 may allow an entity to add other entities as connections, follow other entities, send and receive messages with other entities, join groups, and/or interact with (e.g., create, share, re-share, like, and/or comment on) posts from other entities.

Those skilled in the art will appreciate that online professional network 118 may include other components and/or modules. For example, online professional network 118 may include a homepage, landing page, and/or content feed that provides the latest postings, articles, and/or updates from the entities' connections and/or groups to the entities. Similarly, online professional network 118 may include features or mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, and/or other action performed by an entity in online professional network 118 may be tracked and stored in a database, data warehouse, cloud storage, and/or other data-storage mechanism providing data repository 134.

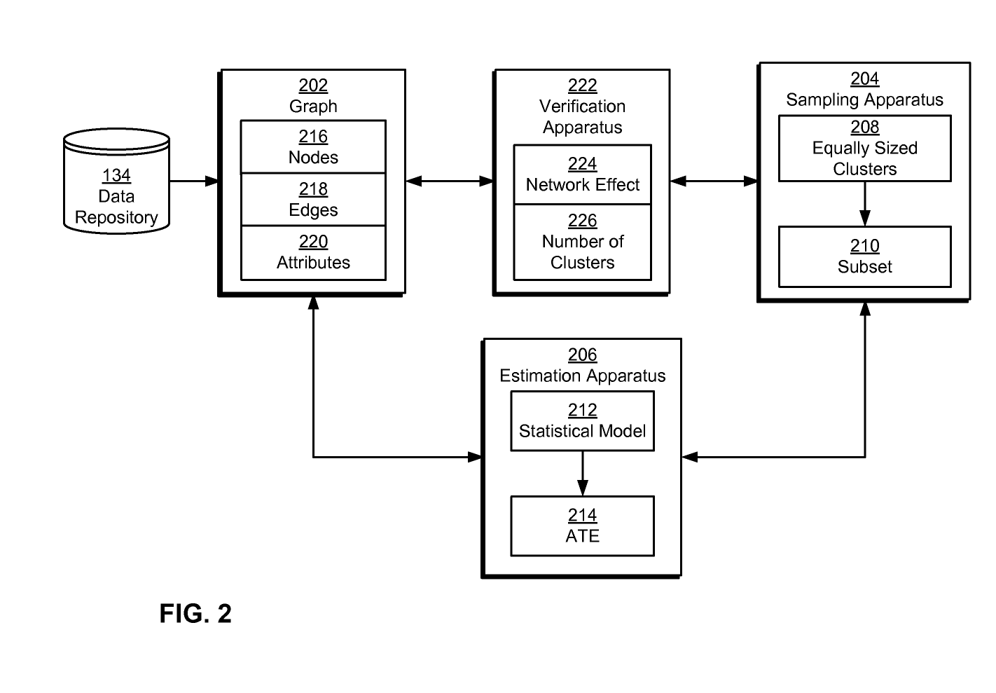

As shown in FIG. 2, data in data repository 134 may be used to form a graph 202 representing entities and the entities' relationships and/or activities in a social network such as online professional network 118 of FIG. 1. Graph 202 may include a set of nodes 216, a set of edges 218, and a set of attributes 220.

Nodes 216 in graph 202 may represent entities in the online professional network. For example, the entities represented by nodes 216 may include individual members (e.g., users) of the online professional network, groups joined by the members, and/or organizations such as schools and companies. Nodes 216 may also represent other objects and/or data in the online professional network, such as industries, locations, posts, articles, multimedia, job listings, ads, and/or messages.

Edges 218 may represent relationships and/or interaction between pairs of nodes 216 in graph 202. For example, edges 218 may be directed and/or undirected edges that specify connections between pairs of members, education of members at schools, employment of members at organizations, business relationships and/or partnerships between organizations, and/or residence of members at locations. Edges 218 may also indicate actions taken by entities, such as creating or sharing articles or posts, sending messages, connection requests, joining groups, and/or following other entities.

Nodes 216 and edges 218 may also contain attributes 220 that describe the corresponding entities, objects, associations, and/or relationships in the online professional network. For example, a node representing a member may include attributes 220 such as a name, username, industry, title, password, and/or email address. Similarly, an edge representing a connection between the member and another member may have attributes 220 such as a time at which the connection was made, the type of connection (e.g., friend, colleague, classmate, employee, following, etc.), and/or a strength of the connection (e.g., how well the members know one another).

In one or more embodiments, the system of FIG. 2 includes functionality to perform network A/B testing, or A/B testing of users in the social network. The system includes a sampling apparatus 204 that selects a subset 210 of nodes 216 (e.g., users) for exposure to a treatment version of a message or other content during an A/B test. For example, sampling apparatus 204 may select a random percentage of users for exposure to a new treatment version of an email, social media post, feature, offer, user flow, article, advertisement, layout, design, and/or other content during an A/B test. Other users in the social network may be exposed to an older control version of the content. In other words, sampling apparatus 204 may generate treatment assignments of the users to a treatment group that is exposed to the treatment version or a control group that is exposed to the control version.

During the A/B test, the users may be exposed to the treatment or control versions, and the users' responses to or interactions with the exposed versions may be monitored. For example, users in the treatment group may be shown the treatment version of a feature after logging into an online professional network, and users in the control group may be shown the control version of the feature after logging into the online professional network. User responses to the control or treatment versions may be collected as clicks, conversions, purchases, comments, new connections, likes, shares, and/or other metrics representing implicit or explicit user feedback from the users.

The system also includes an estimation apparatus 206 that estimates an average treatment effect (ATE) 214 from the results of the A/B test. For example, estimation apparatus 206 may estimate ATE 214 as the difference in click-through rate (CTR) between users exposed to a treatment version of an advertisement and users exposed to a control version of the advertisement. ATE 214 may then be used to determine a subsequent fraction or number of users to be exposed to the treatment version. For example, a positive ATE 214 may be used to ramp up exposure of additional users in the social network to the treatment version, while a negative ATE 214 may be used to reduce or terminate exposure of additional users to the treatment version.

Those skilled in the art will appreciate that the social network may exhibit network effect 224, in which a user's behavior is impacted by the behavior of the user's social neighborhood. Thus, if a treatment version in an A/B test has a significant impact on the user, the effect of the treatment version may spill over to the user's neighbors in the social network, independently of whether the user's neighbors are in the treatment or control groups of the A/B test. For example, a treatment version of a “People You May Know” feature in a social networking website may make more relevant recommendations to the user and thus encourage the user to send more connection requests. However, users in the control group who receive the user's connection requests may visit the social networking website in response to the connection requests and make their own connection requests while at the social networking website. If the metric of interest in the A/B test is the total number of connection requests made, a positive gain may be seen in both the treatment and control groups.

On the other hand, conventional A/B testing techniques may operate under the Stable Unit Treatment Value Assumption (SUTVA), in which the behavior of each user in an A/B test depends only on the user's treatment and not on the treatment of other users in the A/B test. Because such conventional A/B testing techniques may ignore network effect 224 during network A/B testing, estimates produced by the conventional A/B testing techniques may exhibit bias and produce incorrect results.

In one or more embodiments, sampling apparatus 204 and estimation apparatus 206 include functionality to account for network effect 224 during A/B testing of users in the social network. As a result, sampling apparatus 204 and estimation apparatus 206 may have less bias and produce more accurate results than sampling and/or estimation techniques that do not account for network effect 224.

Prior to performing sampling and estimation in a network A/B test, a verification apparatus 222 may verify network effect 224 in the social network. To verify network effect 224, verification apparatus 222 may identify a statistically significant positive correlation between responses of the users in the A/B test and social interference or homophily in the social network. Social interference may represent the “spillover” treatment effect from a user's neighbors in the social network. Homophily may represent the homogeneity in the socio-demographic, behavioral, and/or intrapersonal attributes in the user's social neighborhood (e.g., the user's first- and second-degree connections in the social network).

For example, a user's behavior may be represented by the following linear additive model:

Yᵢ(Z)−α+βZᵢ+γAᵢ^{T}Z+ηAᵢ^{T}Y/l)ᵢᵢ.

In the model, Z is a treatment assignment vector for all users, where Zᵢε{0, 1} is user i's treatment assignment in either the treatment group, as represented by 1, or the control group, as represented by 0. β, γ and η are used to capture treatment effect, network effect 224, and homophily, respectively. Yᵢ(Z) is the response function of the user, given the treatment assignments of all other users in the A/B test. The social interference component is modeled based on the user's total number of treated neighbors and is represented by Aᵢ^{T}Z, where A is the adjacency matrix of graph 202, and A_{.i} is the ith column of A. Homophily is approximated by the average behavior of the user's neighborhood, or Aᵢ^{T}Y/Dᵢᵢ, where D is the diagonal matrix, and:

Dᵢᵢ=Σⱼ₌₁^{N}Aᵢⱼ.

The model may be fit to data from an experiment with uniform random sampling, and the size of each effect may be estimated and tested for statistical significance. Thus, the model may be used to confirm a statistically significant positive correlation of user responses with treatment effect, social interference, and homophily, which in turn may be used to verify network effect 224 in the social network.

Verification apparatus 222 may also use an A/A test to select a number of clusters 226 into which graph 202 is to be partitioned before sampling of users in the clusters is performed by sampling apparatus 204. For example, verification apparatus 222 may select number of clusters 226 and partition graph 202 into clusters 226. Verification apparatus 222 may then divide the clusters between treatment and control groups, show the same message to both groups, and compare the users' responses in the treatment and control clusters. If the responses in the treatment and control clusters are not significantly different, verification apparatus 222 may verify that no bias was introduced in the selected number of clusters 226, and number of clusters 226 may be used by sampling apparatus 204 in subsequent sampling of users during the A/B test.

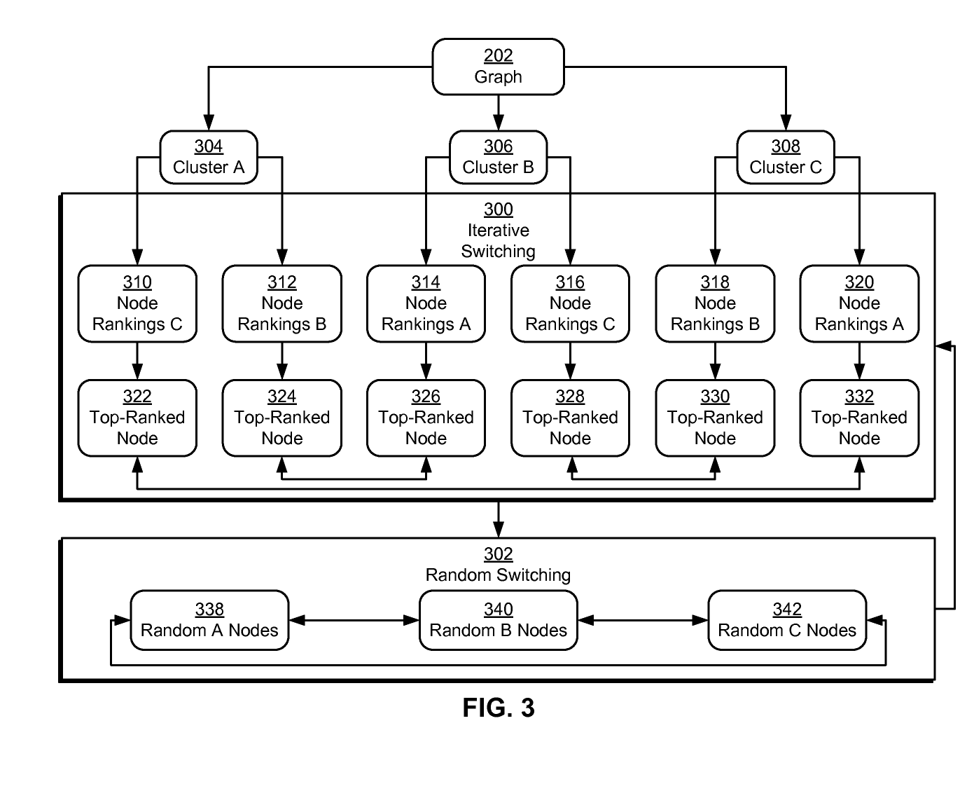

More specifically, sampling apparatus 204 may use number of clusters 226 to calculate a set of substantially equally sized clusters 208 of users in the social network. For example, sampling apparatus 204 may divide the number of nodes in graph 202 by number of clusters 226 to obtain the size of each equally sized cluster. As described in further detail below with respect to FIG. 3, membership of nodes in equally sized clusters 208 may then be calculated by iteratively switching memberships of nodes 216 among equally sized clusters 208 to increase the number of edges in each cluster. After equally sized clusters 208 are produced, sampling apparatus 204 may randomly select a subset of equally sized clusters 208 for exposure to the treatment version. Because the social network is randomly sampled at the cluster level instead of at the user level, network effect 224 across treatment and control groups is reduced over that of uniform random sampling at the user level.

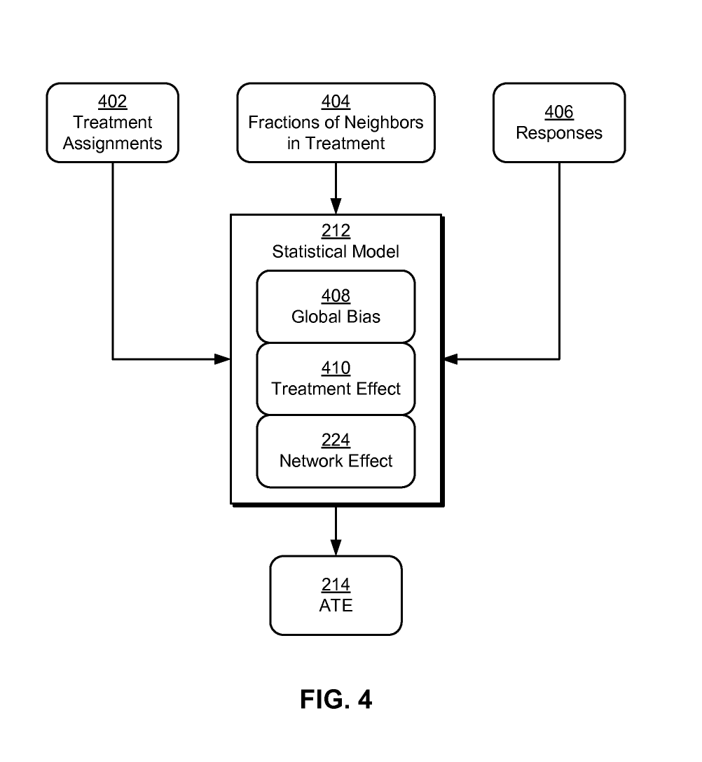

Estimation apparatus 206 may then fit the users' treatment assignments and responses to a statistical model 212 and use statistical model 212 to estimate ATE 214. As described in further detail below with respect to FIG. 4, estimation apparatus 206 may obtain and/or calculate, for each user, the fraction of the user's neighbors exposed to the treatment version in the A/B test. Estimation apparatus 206 may use each user's treatment assignment, fraction of neighbors exposed to the treatment version, and response to estimate a global bias, treatment effect, and network effect 224 in the statistical model. Estimation apparatus 206 may then use the estimated global bias, treatment effect, and/or network effect 224 to estimate ATE 214. Because estimation apparatus 206 accounts for network effect 224 during estimation of ATE 214, estimation apparatus 206 may have less bias, and thus produce a more accurate estimate of ATE 214, than an estimator that does not include network effect 224 in the calculation of ATE 214.

FIG. 3 shows an exemplary calculation of a set of equally sized clusters of users in a social network in accordance with the disclosed embodiments. As shown in FIG. 3, graph 202 may be partitioned into three equally sized clusters: cluster A 304, cluster B 306, and cluster C 308. Graph 202 may include nodes (e.g., nodes 216 of FIG. 2) representing some or all of the users in the social network, as well as edges (e.g., edges 218 of FIG. 2) representing relationships between pairs of the nodes. In some embodiments, all clusters need not be exactly equal in size.

During partitioning of graph 202 into the three equally sized clusters, nodes in graph 202 may be randomly assigned to the clusters. For example, 900 nodes in graph 202 may be randomly assigned to three clusters of 300 nodes each. If nodes in graph 202 cannot be evenly divided among the clusters, the nodes may be divided as evenly as possible among the clusters. For example, 1,000 nodes in graph 202 may be randomly divided into three clusters of 333, 333, and 334 nodes each.

Alternatively, graph 202 may be partitioned into clusters using a variation on a modularity maximization technique. The modularity maximization technique may initially assign each node in graph 202 to a different cluster. For example, 1,000 nodes in graph 202 may initially be assigned to 1,000 different clusters. Next, two clusters may be merged if such merging maximizes a metric representing the modularity of graph 202 (e.g., the strength of division of graph 202 into clusters), up to a maximum cluster size representing the size of each equally sized cluster. If two clusters cannot be merged due to the maximum cluster size constraint, two other clusters that produce the next most optimal increase in modularity while satisfying the maximum cluster size constraint may be merged. After all available clusters have been merged to maximize the modularity of graph 202 within the maximum cluster size, isolated nodes may be assigned to the clusters to complete partitioning of graph 202 into the equally sized clusters.

After nodes of graph 202 are assigned to clusters, an iterative switching 300 of nodes in the clusters may be performed. As mentioned above, iterative switching 300 may be used to increase the number of edges in each cluster. To perform iterative switching 300, node rankings of nodes in each cluster may be generated based on the nodes' ability to increase the number of edges in all clusters. Cluster A 304 may have node rankings C, which ranks nodes in cluster A 304 by descending order of ability to increase in the number of edges in cluster C 308. Cluster A 304 may also have node rankings B, which ranks nodes in cluster A 304 by descending order of ability to increase the number of edges in cluster B 306. Cluster B 306 may have node rankings A 314 and node rankings C 316, which rank nodes in cluster B 306 by descending order of ability to increase the number of edges in clusters A 304 and C 308, respectively. Cluster C 308 may have node rankings B 318 and node rankings A 320, which rank nodes in cluster C 308 by descending order of ability to increase the number of edges in clusters B 306 and A 304, respectively.

Cluster memberships of top-ranked nodes 322-332 from corresponding pairs of node rankings may then be switched. For example, top-ranked node 322 from node rankings C 310 for cluster A 304 may be moved to cluster C 308, and top-ranked node 332 from node rankings A 320 for cluster C 308 may be moved to cluster A 304. Top-ranked node 324 from node rankings B 312 for cluster A 304 may be moved to cluster B 306, and top-ranked node 326 from node rankings A 314 for cluster B 306 may be moved to cluster A 304. Top-ranked node 328 from node rankings C 316 for cluster B 306 may be moved to cluster C 308, and top-ranked node 330 from node rankings B 318 for cluster C 308 may be moved to cluster B 306. After cluster memberships of a pair of nodes are switched, the node rankings may be updated to reflect the switch, and a subsequent iteration of switching top-ranked nodes between two clusters may be performed using the updated node rankings.

On the other hand, the cluster memberships of a pair of top-ranked nodes 322-332 may not be switched if such a switch does not increase the number of edges in both clusters. For example, a node from cluster A 304 may add four edges to cluster B 306 and remove three edges from cluster A 304, while a node from cluster B 306 may add two edges to cluster A 304 and remove one edge from cluster B. While switching the memberships of the two nodes may increase the number of edges in cluster B 306, such a switch may be skipped because the switch may decrease the number of edges in cluster A 304. Alternatively, the switch may not be skipped as long as the switch results in a positive total gain in the number of edges in all of the clusters.

Iterative switching 300 may be performed until the number of edges in the clusters cannot be increased by switching matching pairs of top-ranked nodes 322-332. In other words, iterative switching 300 may stop once a local maximum is reached in optimizing the numbers of edges in clusters A 304, B 306 and C 308. To potentially improve on the local maximum, one or more rounds of iterative switching 300 may be followed by a round of random switching 302, in which the cluster memberships of a pre-specified portion of pairs of nodes in graph 202 are switched. For example, the cluster memberships of a number of random A nodes 338 from cluster A 304, a number of random B nodes 340 from cluster B 306, and a number of random C nodes 342 from cluster C may be switched until the cluster memberships of 5% of the nodes in graph 202 (or some other threshold) have been randomly switched.

Another round of iterative switching 300 may be performed after random switching 302, and the number of edges in the clusters after the second round of iterative switching 300 may be compared to the number of edges in the clusters after the first round of iterative switching 300. If the second round of iterative switching 300 produces an increase in the number of edges in the clusters over the first round of iterative switching 300, another round of random switching 302 may be performed, followed by another round of iterative switching 300. Such alternating of iterative switching 300 and random switching 302 may continue until a round of iterative switching 300 does not increase the number of edges in the clusters over the previous round of iterative switching 300.

Once a round of iterative switching 300 does not increase the number of edges in the clusters over the previous round, switching of cluster memberships among the nodes is discontinued, and existing cluster memberships of nodes from the most recent round of iterative switching 300 and/or the previous round of iterative switching 300 are used. Random sampling of users in the social network may then be conducted by randomly selecting a subset of the equally sized clusters to represent a portion of the social network to be exposed to the treatment version during an A/B test. For example, 10,000 nodes in graph 202 may be partitioned into 20 equally sized clusters of 500 nodes each. If 10% of the nodes are to be exposed to the treatment version in the A/B test, two clusters may be randomly selected for assignment to the treatment group. Users in the selected clusters may be exposed to the treatment version, and users in the remaining 18 clusters may be exposed to the control version.

Because graph 202 is divided into substantially equally sized clusters, subsequent estimation bias caused by varying levels of social influence from treatment clusters of different sizes may be reduced. Network effect across clusters may additionally be reduced by increasing the number of edges within each cluster and reducing the number of edges between clusters through one or more rounds of iterative switching 300 and random switching 302.

FIG. 4 shows the estimation of ATE 214 for a network A/B test in accordance with the disclosed embodiments. As mentioned above, ATE 214 may be estimated using statistical model 212. To produce an estimate of ATE 214, statistical model 212 may be applied to data from the A/B test. The data includes a set of treatment assignments 402 of users in the A/B test and a set of user responses 406 of the users to exposure to treatment or control versions in the A/B test. Treatment assignments 402 may be made by dividing the social network into equally sized clusters and randomly selecting a subset of the equally sized clusters for exposure to the treatment version, as discussed above. The data also includes a set of fractions of neighbors in treatment 404 for the users, which represents, for each user, the fraction of the user's neighbors (e.g., users to which the user is directly connected in the social network) assigned to the treatment group of the A/B test.

Treatment assignments 402, fractions of neighbors in treatment 404, and responses 406 may be used to estimate a global bias 408, a treatment effect 410, and network effect 224 in the A/B test. Global bias 408 may represent influence outside of the social network. For example, global bias 408 may account for propagation of information to the users via channels (e.g., television, newspapers, books, web searches, etc.) outside of the social network and/or the prior of a user responding to the treatment version. Treatment effect 410 may represent the isolated effect of exposure to the treatment version on an outcome metric of interest. For example, treatment effect 410 may account for the difference in CTR between a user's exposure to a new treatment version of a feature and the same user's exposure to an old control version of the feature. Network effect 224 may represent the influence of a user on his/her social neighborhood. For example, network effect 224 may capture the “spillover” effect of the user's exposure to treatment on the user's neighbors, independently of the neighbors' treatment assignments 402.

To estimate global bias 408, treatment effect 410, and network effect 224, statistical model 212 may be fit to treatment assignments 402, fractions of neighbors in treatment 404, and responses 406. In particular, a response function ƒ may be defined as any function that depends on a user's treatment assignment Zᵢε{0, 1}, as defined above, and fraction of treated neighbors σᵢ:

ƒᵢ^{F}(Z,ξᵢ)=g(Zᵢ,σᵢ).

ATE 214 can be expressed as:

$$δ = \frac{1}{N} {\sum }_{i - 1}^{N} {f}_{i} ( Z = 1 , {ξ}_{i} ) - \frac{1}{N} {\sum }_{i - 1}^{N} {f}_{i} ( Z = 0 , {ξ}_{i} ) - {τ}_{1} - {τ}_{0}$$

where δ represents ATE 214, N is the total number of users, ξᵢ represents one or more user-specific traits (e.g., a user's local neighborhood structure), τ₁ is the expected response when the treatment version is applied globally (e.g., to all users), and τ₀ is the expected response when the control version is applied globally. The expression for ATE 214 may then be converted into the following:

δ=g(1,1)−g(0,0).

Various response functions g(•) may be chosen to model the users' behaviors. For example, user behaviors may be modeled using the following linear additive model:

g(Zᵢ,σᵢ)=α+βZᵢ+γσᵢ,

where α represents global bias 408, β represents treatment effect 410, and γ represents network effect 224. α, β, and γ can be estimated from treatment assignments 402, fractions of neighbors in treatment 404, and/or observation data of all user responses 406 as \hat{α}, \hat{β}, and \hat{γ}. Using the expression for ATE 214 above, ATE 214 can be estimated as:

\hat{δ}_{L}_{₁}=\hat{β}−\hat{γ}.

In other words, an estimate of ATE 214 may be calculated using estimates for treatment effect 410 and network effect 224.

The linear model above may be generalized further by considering different response functions for users in treatment and control groups:

$$g ( {Z}_{i} , {σ}_{i} ) = \{ \begin{matrix}{α}_{0} + {γ}_{0} {σ}_{i} , & if {Z}_{i} & 0 \\ {α}_{1} + {γ}_{1} {σ}_{i} , & if {Z}_{i} & 1\end{matrix}$$

where α₀ and γ₀ are learned from observation data (e.g., responses 406) of users in the control group, and α₁ and γ₁ are learned from observation data of users in the treatment group. Because the response functions are divided between users in the treatment group and users in the control group and all users in each group are exposed to the same version (e.g., treatment or control), treatment effect 410, as represented by β, is 0 in both response functions. ATE 214 may thus be estimated as: \hat{δ}_{L}_{₁₁}−\hat{α}₁+\hat{γ}₁−\hat{α}₀.
In this example, ATE 214 may be estimated using estimates for global bias 408 for users exposed to the treatment version, global bias 408 for users exposed to the control version, and network effect 224 for users exposed to the treatment version.

The linear models described above may be fit to treatment assignments 402, fractions of neighbors in treatment 404, and responses 406 using a regression technique such as ordinary least squares. ATE 214 may then be estimated using the above expressions, which include estimates for global bias 408, treatment effect 410, and/or network effect 224 from the linear models.

After ATE 214 is estimated using statistical model 212, ATE 214 may be used to select a fraction of additional users in the social network for subsequent exposure to the treatment version. For example, the value of ATE 214 may be used to evaluate the effect size associated with the network A/B test. If the effect size indicates a positive response to the treatment version, subsequent exposure of users to the treatment may be ramped up based on the effect size. If the effect size indicates a negative response to the treatment version, subsequent exposure of users to the treatment version may be stopped to prevent alienation of additional users. In another example, an estimate of ATE 214 that indicates a positive response to the treatment version may facilitate rejection of a null hypothesis that states that the treatment and control versions of the A/B test have the same conversion rate.

Because statistical model 212 accounts for global bias 408, treatment effect 410, and network effect 224, statistical model 212 may estimate ATE 214 with less bias and/or variance than models that do not consider network effect 224 and/or that remove responses 406 from estimation for users with fractions of neighbors in treatment 404 that do not exceed a threshold. Consequently, the estimate of ATE 214 from statistical model 212 may guide decisions related to A/B testing in a social network setting more effectively than estimates of ATE 214 from other models.

Those skilled in the art will appreciate that other types of statistical models may be used to estimate global bias 408, treatment effect 410, network effect 224, and ATE 214. For example, statistical model 212 may be an exponential model, logistic function model, and/or other type of model that can be fit to treatment assignments 402, fractions of neighbors in treatment 404, and/or responses 406 to produce an estimate of ATE 214.

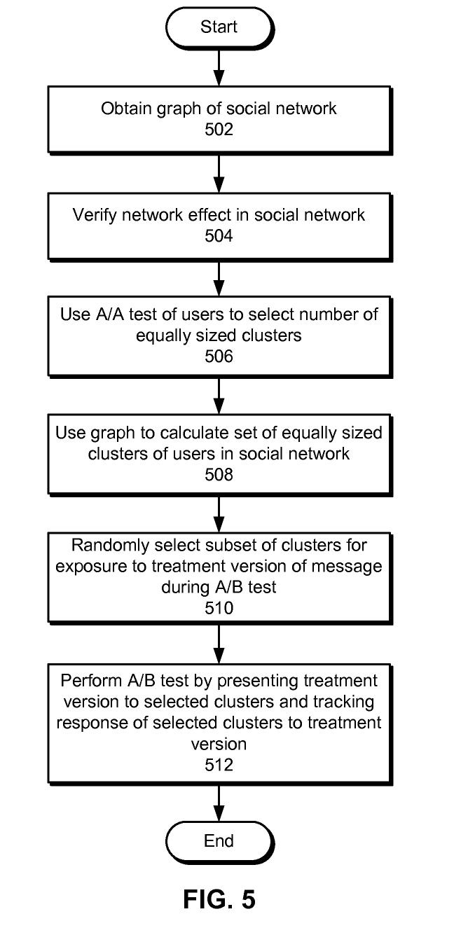

FIG. 5 shows a flowchart illustrating the process of sampling users in network A/B testing in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

First, a graph of a social network is obtained (operation 502). The graph may include a set of nodes representing a set of users, as well as a set of edges representing relationships between pairs of the users. The nodes may additionally represent a set of companies, and the relationships modeled by the edges may include an employment of a user at a company, a connection of the user to another user, and/or a following of a user or company by another user.

Next, a network effect is verified in the social network (operation 504). To verify the network effect, a statistically significant positive correlation between responses of the users to the treatment version of an A/B test and social interference or homophily in the social network may be identified, as described above. An A/A test of the users is also used to select a number of equally sized clusters (operation 506) for use in the A/B test. For example, a number of equally sized clusters may be selected, and the graph may be partitioned into the given number of clusters. The clusters may then be divided between treatment and control groups, and the same message may be shown to both groups to compare the users' responses in the treatment and control clusters. If the responses in the treatment and control clusters are not significantly different, a lack of bias may be confirmed, and the selected number of clusters may be used in subsequent partitioning of the graph for A/B testing.

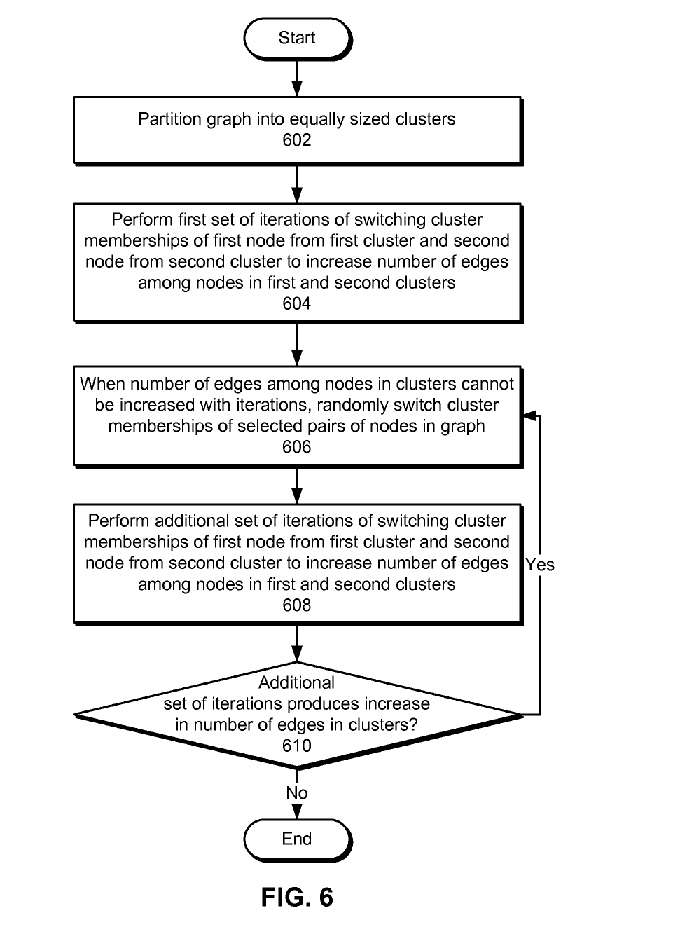

To partition the graph for A/B testing, the graph is used to calculate a set of equally sized clusters of users in the social network (operation 508). For example, the size of the graph may be divided by the number of equally sized clusters selected in operation 506 to obtain a cluster size of the equally sized clusters, and the graph may be partitioned into the equally sized clusters according to the cluster size. As described in further detail below with respect to FIG. 6, calculation of the equally sized clusters may then be performed by iteratively switching memberships of the nodes among the equally sized clusters to increase a number of edges in each of the equally sized clusters.

Next, a subset of the clusters is randomly selected for exposure to the treatment version of a message during the A/B test (operation 510). For example, if 10% of users are to be exposed to the treatment version in the A/B test, 10% of the clusters may be randomly selected, and all users in the selected clusters may be assigned to the treatment group for the A/B test. Users not in the selected clusters may be assigned to the control group for the A/B test.

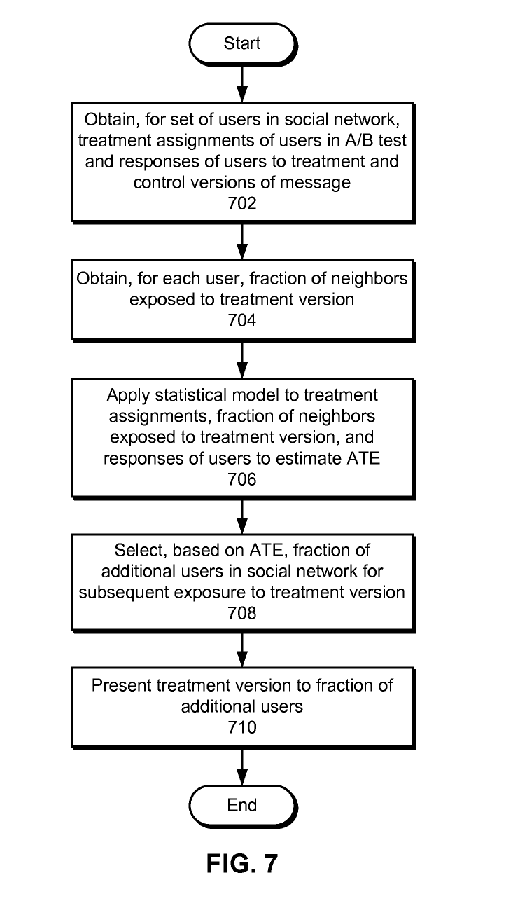

Finally, the A/B test is performed by presenting the treatment version to the selected clusters and tracking the response of the selected clusters to the treatment version (operation 512). For example, a treatment version of an email, offer, advertisement, webpage, feature, layout, design, article, and/or other message may be shown to the selected clusters, and a control version of the same message may be shown to other clusters, which form a control group for the A/B test. Responses of the users in the treatment and control groups may be tracked using metrics that measure CTR, conversion rates, revenue, comments, connection requests, and/or other values associated with the users' behavior. The responses may then be analyzed to select a fraction of additional users for subsequent exposure to the treatment version, and the treatment version may be presented to the selected fraction of additional users, as described in further detail below with respect to FIG. 7.

FIG. 6 shows a flowchart illustrating the process of calculating equally sized clusters of users in a social network in accordance with the disclosed embodiments. In one or more embodiments, one or more of the steps may be omitted, repeated, and/or performed in a different order. Accordingly, the specific arrangement of steps shown in FIG. 6 should not be construed as limiting the scope of the embodiments.

Initially, a graph of the users in the social network is partitioned into equally sized clusters (operation 602). The graph may be partitioned into the clusters by randomly assigning nodes in the graph to clusters and/or using a modularity maximization technique. Next, a first set of iterations of switching cluster memberships of a first node from a first cluster and a second node from a second cluster to increase the number of edges among nodes in the first and second clusters is performed (operation 604). For example, nodes in each cluster may be ranked in descending order of the nodes' ability to increase the number of edges in every other cluster, and the top-ranked nodes from each pair of clusters may be switched. As a result, the cluster membership of a top-ranked node from a first node ranking of nodes in the first cluster may be switched with the cluster membership of a top-ranked node from a second node ranking of nodes in the second cluster to increase the number of edges in one or both clusters. After a switch is made, the node rankings may be updated to reflect the switch, and additional switches of top-ranked nodes may be made until the number of edges in the clusters cannot be increased.

When the number of edges among nodes in the clusters cannot be increased with the iterations, the cluster memberships of selected pairs of nodes in the graph are randomly switched (operation 606). For example, the cluster memberships of 5% of the nodes may be randomly switched to potentially improve on the local maximum reached during iterative switching of the nodes' cluster memberships. An additional set of iterations of switching the cluster memberships of pairs of nodes to increase the number of edges among nodes in the first and second clusters may then be performed (operation 608) to determine if the additional set of iterations produces an increase in the number of edges in the clusters (operation 610). In the additional set of iterations, nodes in each cluster may be ranked in descending order of the nodes' ability to increase the number of edges in every other cluster, and the top-ranked nodes from each pair of clusters may be switched. After a switch is made, the node rankings may be updated to reflect the switch, and additional switches of top-ranked nodes may be made until the number of edges in the clusters cannot be increased. If the additional set of iterations does not improve upon the total number of edges in the clusters produced by the first set of iterations, the clusters formed using the first set of iterations may be used in sampling during a network A/B test.

If the additional set of iterations improves upon the total number of edges in the clusters produced by the first set of iterations, another round of random switching is performed (operation 606), followed by another round of iterative switching of the cluster memberships to increase the number of edges among nodes in the clusters (operation 608). Such alternating of iterative and random switching of cluster memberships of nodes may continue until a set of iterations does not produce an increase in the number of edges among nodes in the clusters over a previous set of iterations.

FIG. 7 shows a flowchart illustrating the process of performing bias correction and estimation in network A/B testing in accordance with the disclosed embodiments. In one or more embodiments, one or more of the steps may be omitted, repeated, and/or performed in a different order. Accordingly, the specific arrangement of steps shown in FIG. 7 should not be construed as limiting the scope of the embodiments.

Initially, a set of treatment assignments of users in an A/B test and responses of the users to treatment and control versions of a message are obtained (operation 702). The treatment assignments and responses may be obtained for users in a social network such as an online professional network. The treatment assignments may be made by calculating a set of equally sized clusters of the users in the social network and randomly selecting a subset of the equally sized clusters foe exposure to the treatment version during the A/B test, as described above.

Next, for each user, a fraction of neighbors exposed to the treatment version is obtained (operation 704). For example, the fraction of neighbors exposed to the treatment version may be obtained by identifying the user's neighbors (e.g., first-degree connections) in the social network using a graph of the social network, matching the neighbors to the neighbors' treatment assignments, and using the neighbors' treatment assignments to calculate the fraction of neighbors exposed to the treatment version.

A statistical model is applied to the treatment assignments, fraction of neighbors exposed to the treatment version, and the responses of the users to estimate an ATE (operation 706) for the A/B test. The treatment assignments, fraction of neighbors exposed to the treatment version, and responses may be used to estimate a global bias, treatment effect, and network effect in the statistical model. The estimated global bias, treatment effect, and/or network effect may then be used to estimate the ATE. For example, an ordinary least squares technique may be used to estimate the global bias, treatment effect, and/or network effect in one or more linear regression models. The estimated treatment effect and network effect may then be used by one of the linear regression models to estimate the ATE. Alternatively, the estimated global bias for users exposed to the treatment version, the estimated global bias for users exposed to the control version, and the estimated network effect for users exposed to the treatment version may be used by a different linear regression model to estimate the ATE.

A fraction of additional users in the social network for subsequent exposure to the treatment version is then selected based on the ATE (operation 708). For example, the estimated ATE may be used to ramp up exposure of users in the social network to the treatment version and/or facilitate rejection of a null hypothesis of the A/B test. Finally, the treatment version is presented to the fraction of additional users (operation 710).

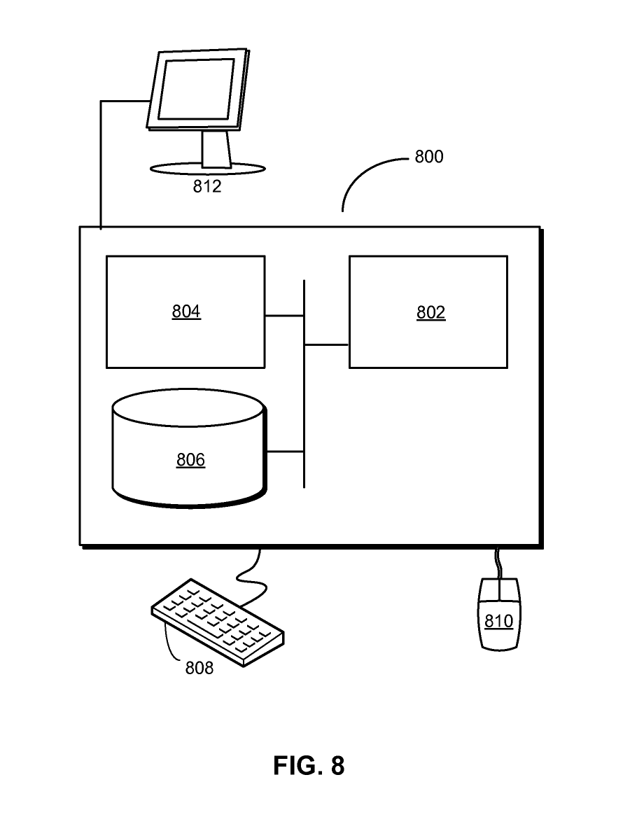

FIG. 8 shows a computer system 800 in accordance with an embodiment. Computer system 800 may correspond to an apparatus that includes a processor 802, memory 804, storage 806, and/or other components found in electronic computing devices. Processor 802 may support parallel processing and/or multi-threaded operation with other processors in computer system 800. Computer system 800 may also include input/output (I/O) devices such as a keyboard 808, a mouse 810, and a display 812.

Computer system 800 may include functionality to execute various components of the present embodiments. In particular, computer system 800 may include an operating system (not shown) that coordinates the use of hardware and software resources on computer system 800, as well as one or more applications that perform specialized tasks for the user. To perform tasks for the user, applications may obtain the use of hardware resources on computer system 800 from the operating system, as well as interact with the user through a hardware and/or software framework provided by the operating system.

In one or more embodiments, computer system 800 provides a system for performing network A/B testing. The system may include a sampling apparatus that obtains a graph of a social network and uses the graph to calculate a set of equally sized clusters of the users in the social network by iteratively switching memberships of the nodes among the equally sized clusters to increase a number of edges in each of the equally sized clusters. The sampling apparatus may also randomly select a subset of the equally sized clusters for exposure to a treatment version during an A/B test.

The system may also include an estimation apparatus. The estimation apparatus may obtain a set of treatment assignments, a set of fractions of neighbors exposed to the treatment version, and a set of responses of users to the treatment version and a control version in the A/B test. The estimation apparatus may apply a statistical model to the treatment assignments, fractions of neighbors exposed to the treatment version, and responses to estimate an ATE for the users. The estimation apparatus may then select, based on the ATE, a fraction of additional users in the social network for subsequent exposure to the treatment version and present the treatment version to the fraction of additional users.

The system may further include a verification apparatus. Prior to performing the A/B test, the verification apparatus may verify a network effect in the social network. The verification apparatus may also use an A/A test of the set of users to select a number of the equally sized clusters before the sampling apparatus calculates the set of equally sized clusters.

In addition, one or more components of computer system 800 may be remotely located and connected to the other components over a network. Portions of the present embodiments (e.g., sampling apparatus, estimation apparatus, verification apparatus, etc.) may also be located on different nodes of a distributed system that implements the embodiments. For example, the present embodiments may be implemented using a cloud computing system that performs sampling and estimation during network A/B testing of a set of remote users.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a graph of a social network, wherein the graph comprises:
a set of nodes representing a set of users; and
a set of edges representing relationships between pairs of the nodes;
calculating, by one or more computer systems, a set of equally sized clusters of the users in the social network by iteratively switching memberships of the nodes among the equally sized clusters to increase a number of edges in each of the equally sized clusters;
randomly selecting a subset of the equally sized clusters for exposure to a treatment version of a message during an A/B test; and
performing, by the one or more computer systems, the A/B test by presenting the treatment version to the selected clusters and tracking a response of the selected clusters to the treatment version.

2. The method of claim 1, wherein calculating the set of equally sized clusters of the users in the social network comprises:
partitioning the graph into substantially equally sized clusters, wherein the substantially equally sized clusters comprise a first cluster and a second cluster; and
performing a first set of iterations of switching cluster memberships of a first node from the first cluster and a second node from the second cluster to increase a number of edges among nodes in the first and second clusters.

3. The method of claim 2, wherein calculating the set of equally sized clusters of the users in the social network further comprises:
when the number of edges among nodes in the first and second clusters cannot be increased using the first set of iterations, randomly switching the cluster memberships of selected pairs of the nodes in the graph;
performing a second set of iterations of switching cluster memberships of a first node from the first cluster and a second node from the second cluster to increase the number of edges among nodes in the first and second clusters; and
discontinuing switching of the cluster memberships when the second set of iterations does not produce an increase in the number of edges among nodes in the first and second clusters.

4. The method of claim 3, wherein switching the cluster memberships of the first node and the second node to increase the number of edges among nodes in the first and second clusters comprises:
generating, for the first and second clusters, node rankings reflecting ability of nodes in the first and second clusters to increase the number of edges in other clusters if moved to the other clusters; and
switching the cluster memberships of:
a first top-ranked node from a first node ranking of nodes in the first cluster to increase the number of edges in the second cluster; and
a second top-ranked node from a second node ranking of nodes in the second cluster to increase the number of edges in the first cluster.

5. The method of claim 2, wherein the graph is partitioned into the equally sized clusters using at least one of:
a randomization technique; and
a modularity maximization technique.

6. The method of claim 1, further comprising:
selecting a fraction of additional users in the social network for subsequent exposure to the treatment version by analyzing the response to the treatment version; and
presenting the treatment version to the fraction of additional users

7. The method of claim 6, wherein selecting the fraction of additional users in the social network for subsequent exposure to the treatment version by analyzing the responses of the users to the treatment version and the control version comprises:
obtaining a set of treatment assignments of the users, wherein the treatment assignments indicate exposure of the users to the control version or the treatment version;
obtaining, for each of the users, a fraction of neighbors exposed to the treatment version in the A/B test;
applying a statistical model to the treatment assignments and the fraction of neighbors exposed to the treatment version to estimate an average treatment effect (ATE) for the A/B test; and
selecting, based on the ATE, the fraction of additional users in the social network for subsequent exposure to the treatment version.

8. The method of claim 1, further comprising:
prior to performing the A/B test, verifying a network effect in the social network by identifying a statistically significant positive correlation between responses of the users to the treatment version and social interference or homophily in the social network.

9. The method of claim 1,
wherein the set of nodes further represent a set of companies, and
wherein the set of relationships comprises at least one of:
an employment of a user at a company;
a connection of the user to another user; and
a following of the user or the company by the other user.

10. The method of claim 1, further comprising:
using an A/A test of the set of users to select a number of the equally sized clusters prior to calculating the set of equally sized clusters.

11. The method of claim 1, wherein randomly selecting the subset of the equally sized clusters for exposure to the treatment version during the A/B test comprises:
selecting a random subset of the equally sized clusters to represent a portion of the social network to be exposed to the treatment version during the A/B test.

12. An apparatus, comprising:
one or more processors; and
memory storing instructions that, when executed by the one or more processors, cause the apparatus to:
obtain a graph of a social network, wherein the graph comprises:
a set of nodes representing a set of users; and
a set of edges representing relationships between pairs of the nodes;
calculate a set of equally sized clusters of the users in the social network by iteratively switching memberships of the nodes among the equally sized clusters to increase a number of edges in each of the equally sized clusters;
randomly select a subset of the equally sized clusters for exposure to a treatment version of a message during an A/B test; and
perform the A/B test by presenting the treatment version to the selected clusters and tracking a response to the treatment version from the selected clusters.

13. The apparatus of claim 12, wherein calculating the set of equally sized clusters of the users in the social network comprises:
partitioning the graph into substantially equally sized clusters, wherein the substantially equally sized clusters comprise a first cluster and a second cluster; and
performing a first set of iterations of switching cluster memberships of a first node from the first cluster and a second node from the second cluster to increase a number of edges among nodes in the first and second clusters.

14. The apparatus of claim 13, wherein calculating the set of equally sized clusters of the users in the social network further comprises:
when the number of edges among nodes in the first and second clusters cannot be increased using the first set of iterations, randomly switching the cluster memberships of selected pairs of the nodes in the graph;
performing a second set of iterations of switching cluster memberships of a first node from the first cluster and a second node from the second cluster to increase the number of edges among nodes in the first and second clusters; and
discontinuing switching of the cluster memberships when the second set of iterations does not produce an increase in the number of edges among nodes in the first and second clusters.

15. The apparatus of claim 13, wherein switching the cluster memberships of the first node and the second node to increase the number of edges among nodes in the first and second clusters comprises:
generating, for the first and second clusters, node rankings reflecting ability of nodes in the first and second clusters to increase the number of edges in other clusters if moved to the other clusters; and
switching the cluster memberships of:
a first top-ranked node from a first node ranking of nodes in the first cluster to increase the number of edges in the second cluster; and
a second top-ranked node from a second node ranking of nodes in the second cluster to increase the number of edges in the first cluster.

16. The apparatus of claim 13, wherein the graph is partitioned into the equally sized clusters using at least one of:
a randomization technique; and
a modularity maximization technique.

17. The apparatus of claim 12, wherein randomly selecting the subset of the equally sized clusters for exposure to the treatment version during the A/B test comprises:
selecting a random subset of the equally sized clusters to represent a portion of the social network to be exposed to the treatment version during the A/B test.

18. A system, comprising:
a sampling non-transitory computer readable medium comprising instructions that, when executed by one or more processors, cause the system to:
obtain a graph of a social network, wherein the graph comprises:
a set of nodes comprising a set of users; and
a set of edges representing relationships between pairs of the nodes;
use the graph to calculate a set of equally sized clusters of the users in the social network by iteratively switching memberships of the nodes among the equally sized clusters to increase a number of edges in each of the equally sized clusters; and
randomly selecting one or more clusters from the set of equally sized clusters for exposure to a treatment version of a message during an A/B test; and
an estimation non-transitory computer readable medium comprising instructions that, when executed by the one or more processors, cause the system to:
perform the A/B test by presenting the treatment version to the selected clusters and tracking a response to the treatment version from the selected clusters;
select a fraction of additional users in the social network for subsequent exposure to the treatment version by analyzing the response to the treatment version; and
present the treatment version to the fraction of additional users.

19. The system of claim 18, wherein calculating the set of equally sized clusters of the users in the social network comprises:
partitioning the graph into substantially equally sized clusters, wherein the substantially equally sized clusters comprise a first cluster and a second cluster; and
performing a first set of iterations of switching cluster memberships of a first node from the first cluster and a second node from the second cluster to increase a number of edges among nodes in the first and second clusters.

20. The system of claim 19, wherein calculating the set of equally sized clusters of the users in the social network further comprises:
when the number of edges among nodes in the first and second clusters cannot be increased using the first set of iterations, randomly switching the cluster memberships of selected pairs of the nodes in the graph;
performing a second set of iterations of switching cluster memberships of a first node from the first cluster and a second node from the second cluster to increase the number of edges among nodes in the first and second clusters; and
discontinuing switching of the cluster memberships when the second set of iterations does not produce an increase in the number of edges among nodes in the first and second clusters.
